(19) United States
(12) Patent Application Publication
(10) Pub. No.: US 2014/0099473 A1
(43) Pub. Date: Apr. 10, 2014

(54) Mat for All Vehicles

(71) Applicant: SHIGEYUKI AOKI, Nishikasugai-Gun Aichi (JP)

(72) Inventor: SHIGEYUKI AOKI, Nishikasugai-Gun Aichi (JP)

(21) Appl. No.: 13/645,252

(22) Filed: Oct. 4, 2012

(51) Int. Cl. B32B 3/30

(52) U.S. Cl. 428/156

(57) ABSTRACT

The invention is related to a mat for all vehicles. The vehicle includes at least one mat placement area which is either under a driver seat or under an adjacent passenger seat. The mat is placed on the mat placement area either under the driver seat or under the adjacent passenger seat. The mat includes a first corner zone and a second corner zone opposite to the first corner zone wherein each of the first and second corner zones is formed with a plurality of curved, intersected grooves so that the first and second corner zones are bendable by using the grooves when the mat is placed on one of the at least one mat placement area so that the mat can completely engage one of the at least one mat placement area.

### BACKGROUND OF THE INVENTION

1. Field of the Invention

The invention relates to mats and more particularly to a mat placed on the mat placement area under a driver seat or an adjacent passenger seat of one of a great variety of vehicles.

2. Description of Related Art

A user may bring dirt and sand into a car when enters the car. Thus, the original carpet in the car may be polluted. Further, the original carpet is affixed on the car floor and it is impossible of removing the carpet for cleaning. In view of above, the user may install an additional mat in the car floor for foot stepping purpose in order to keep the car floor clean and facilitate removal and cleaning of the mat.

As mentioned above, a conventional car mat 1 is shown in FIG. 1 and comprises a rectangular flexible body 11 having a plurality of cavities 12 formed on the body 11. However, dirt trapped in the cavities 12 is not easy to remove because the cavities 12 are much recessed. As a result, it is difficult of completely cleaning the car mat 1.

Further, the body 11 is a piece of rectangular and not adapted to the floor of a great variety of cars. It is typical that car mat manufacturers have to produce many different car mats to accommodate different floor designs of cars. This inevitably increases the manufacturing cost of car mats. Furthermore, the floor under the driver seat is not even and that under the adjacent passenger seat is also uneven differently in most car designs. This also increases the manufacturing cost of car mats since such uneven floors of car inside are required to be considered in the design and manufacturing of car mats.

Moreover, the typical car mat 1 is of common design and is somewhat thick. In often times that a gap may exist between the car mat and the car floor when the car mat 1 is placed on a raised portion of the car floor. Dirt may be accumulated in the gap. And in turn the dirt can pollute the original car floor. Further, the car mat 1 placed on the uneven car floor may interfere with the driving due to the car mat 1 may clog the brake or the brake pedal or gas pedal adjacent to the driver seat And in turn, it may adversely affect the safety of a running car.

In view of above, it is desired to provide a mat for the floor of all vehicles and such is a problem to be solved by the mat manufacturers.

### SUMMARY OF THE INVENTION

It is therefore one object of the invention to provide a mat for all vehicles, the mat being capable of not only keeping a car clean but also fully engaging an area under a driver seat or an adjacent passenger seat by overcoming irregularities on the area.

For achieving above object, the invention discloses a mat for all vehicles including at least one mat placement area under a driver seat or an adjacent passenger seat. The mat is placed on the mat placement area either under the driver seat or under the adjacent passenger seat. The mat includes a front surface, the front surface including a substantial foot resting zone, a first corner zone and a second corner zone opposite to the first corner zone.

Wherein each of the first and second corner zones is formed with a plurality of curved, intersected grooves so that the first and second corner zones are bendable by using the grooves when the mat is placed on one of the at least one mat placement area so that the mat can completely engage one of the at least one mat placement area.

The above object, features and advantages of the invention will become apparent from the following detailed description taken with the accompanying drawings.

### BRIEF DESCRIPTION OF THE DRAWINGS

FIG. 1 is a perspective view of a conventional car mat;

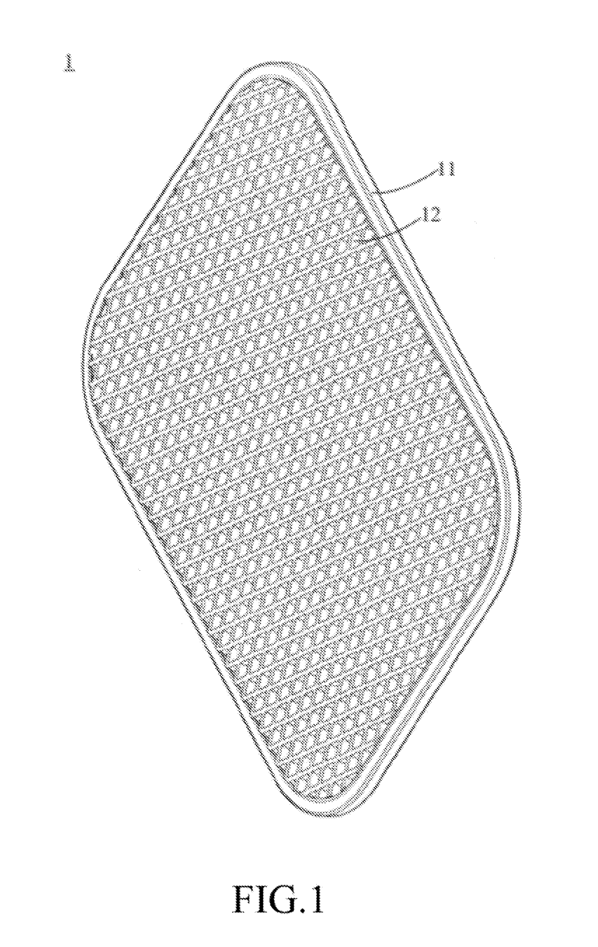

FIG. 2A is a front view of a mat for all vehicles according to the invention;

FIG. 2B is a front view of a mat for all vehicles according to the invention after being cut to accommodate the car floor;

FIG. 3A is an environmental view of a mat according to the invention placed on the car floor;

FIG. 3B is a fragmentary view of a mat according to the invention;

FIG. 3C is an environmental view of the mat for all vehicles of the invention cut into a shape as shown in FIG. 2B and placed on the car floor;

FIG. 4 is a side view of a mat according to the invention; and

FIG. 5 is a bottom view of a mat according to the invention.

### DETAILED DESCRIPTION OF THE INVENTION

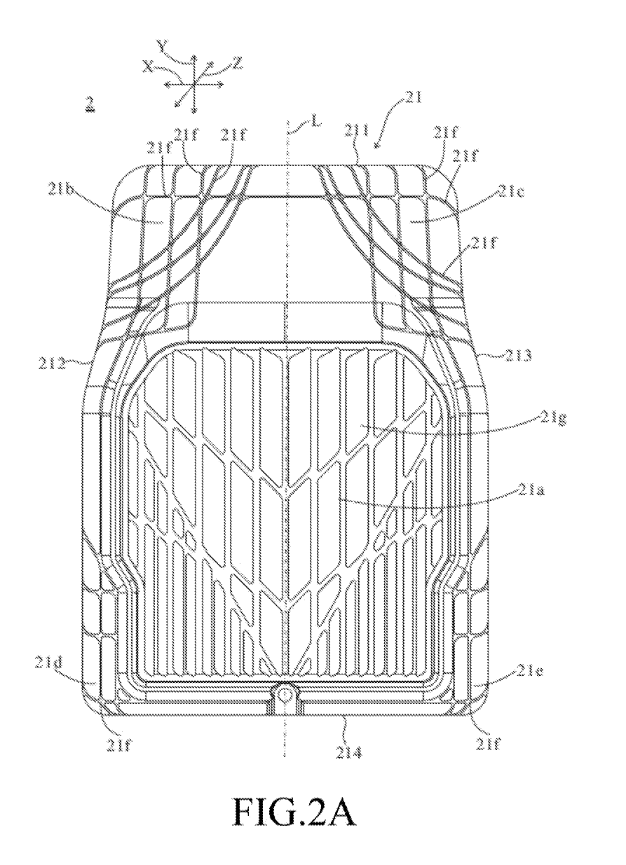

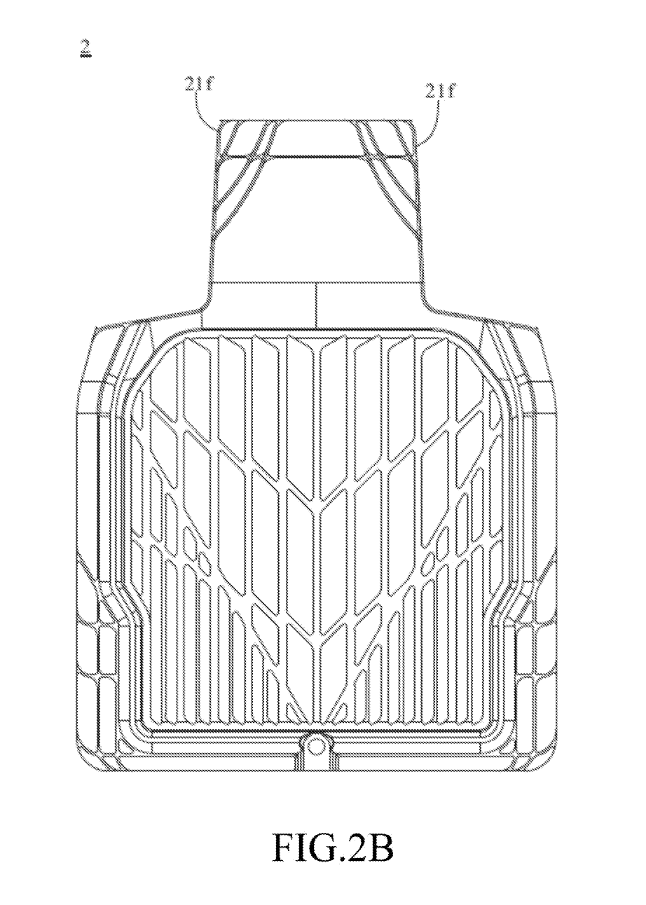

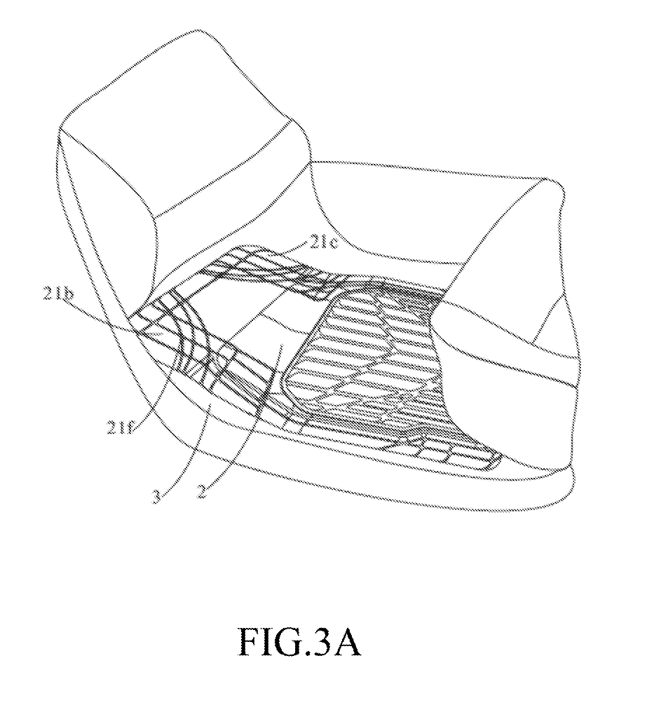

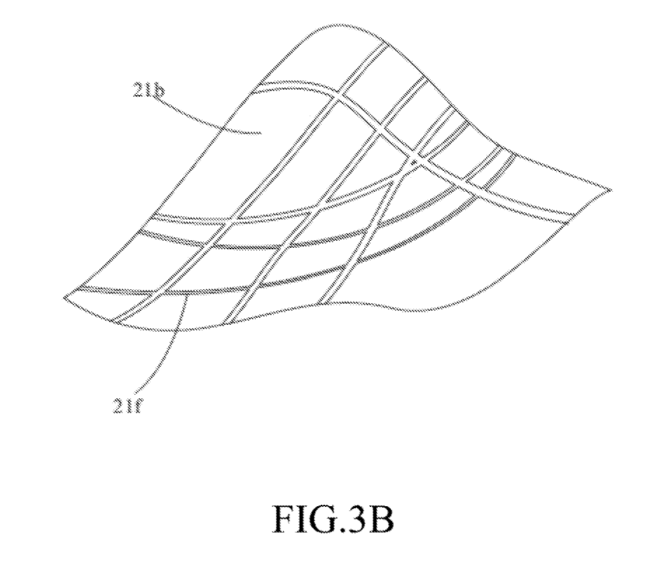

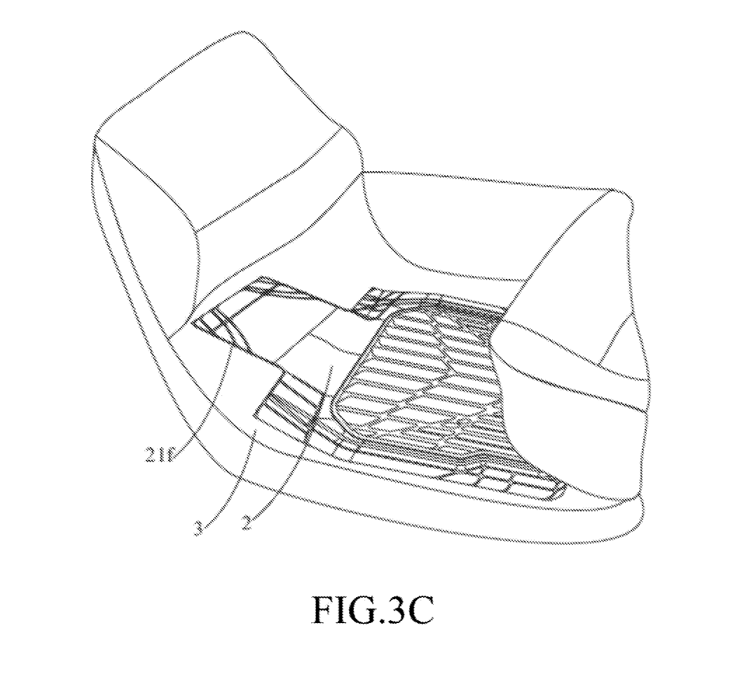

Referring to FIGS. 2A and 3A wherein FIG. 2A is a front view of a mat 2 for all vehicles according to the invention, and FIG. 3A is an environmental view of the mat 2 according to the invention placed on the car floor. The car has at least one mat placement area 3. The mat placement area 3 can be one placed under a driver seat or one placed under an adjacent passenger seat. The mat 2 is placed on the mat placement area 3. The mat 2 comprises a front surface 21 which includes a substantial foot resting zone 21a, a first corner zone 21b at one end of a front portion of the mat 2, a second corner zone 21c at the other end opposed to the first corner zone 21b of the front portion of the mat 2, a third corner zone 21d at one end of a rear portion of the mat 2, a fourth corner zone 21e at the other end opposed to the third corner zone 21d of the rear portion of the mat 2, a first side 211, a second side 212, a third side 213 opposite to the second side 212, and a fourth side 214 opposite to the first side 211. Both ends of the first side 211 are joined both sides 212, 213 respectively. Both ends of the fourth side 214 are joined both sides 212, 213 respectively.

Now further describes the relative position relation of the various areas. The foot resting zone 21a is the place where the foot of a driver or passenger touches the floor of the car and is adjacent to a fourth side 214 of the foot resting zone 21a. The first corner zone 21b is at a joining portion of the first side 211 and second side 212. The second corner zone 21c is at a joining portion of the first side 211 and third side 213. The third corner zone 21d is at a joining portion of second side 212 and the fourth side 214. The fourth corner zone 21e is at a joining portion of the fourth side 214 and third side 213.

Referring FIGS. 2A and 3A again, a plurality of curved, intersected grooves 21f are formed on the first corner zone 21b and the second corner zone 21c respectively. Thus, the first and second corner zones 21b, 21c are adapted to bend to completely engage one of the at least one mat placement area 3 when the mat 2 is placed on an uneven portion of the mat placement area 3 which is one placed under either a driver seat or one placed under an adjacent passenger seat. It is understood that the mat placement area 3 placed either under the driver seat or under the adjacent passenger seat are not the same. For example, they are uneven (i.e., projected) in order to accommodate the curved shape of wheel (i.e., so called wheel arch) or gear box. Advantageously, the provision of the grooves 21f in each of the first corner zone 21b and the second corner zone 21c enable the mat placement area 3 to bend along the unevenness of the car floor. Therefore, the mat 2 of the invention is capable of completely engaging the mat placement area 3 when the mat 2 is placed on the mat placement area 3 under the drive seat. Further, the mat 2 of the invention is capable of bending to completely engage the mat placement area 3 when the mat 2 is placed on the mat placement area 3 under the adjacent passenger seat. Therefore, there is no need for car mat manufacturers to produce different car mats due to shape differences of the mat placement area 3 and unevenness of the car floor.

In view of above, the mat 2 of the invention is capable of bending to completely engage the mat placement area 3 when the mat 2 is placed on different mat placement areas of various vehicles. Referring to FIGS. 2A, 3A, and 3B, wherein FIG. 3B is a fragmentary view of the mat 2 showing a bending state of the first corner zone 21b. The curved, intersected grooves 21f on the first corner zone 21b extend from second side 212 and third side 213 to the first side 211. The mat 2 is thus bendable on the grooves 21f from the first side 211 to either second side 212 or third side 213 (i.e., being inclined). In detail, as indicated by a three dimension form of Cartesian coordinate system (e.g., X-Y-Z axes) on top of FIG. 2A, the grooves 21f are directed toward three-dimension. Thus, as shown in FIG. 3B, the mat 2 is capable of bending toward different directions, thereby accommodating irregularities of the mat placement areas 3 of all vehicles.

Furthermore, gas pedal, brake pedal, or clutch pedal of some vehicles are provided in front of a floor under driver seat. These pedals may interfere with the placement of the mat 2 of the invention on the car floor even after bending the mat 2 of the invention toward different directions. Therefore, advantageously the mat 2 of the invention can be cut to adjust its shape in order to accommodate the position of the gas pedal, brake pedal, or clutch pedal. For example, the grooves 21f can be taken as cutting lines so that a user can cut along the grooves 21f to obtain a desired shape depending on requirements. For instance, in a front view of FIG. 2B it shows the mat obtained by cutting along the grooves 21f by a user. In FIG. 3C, it shows the cut mat 2 placed on the mat placement area 3 of the car floor by a user after cutting the mat 2 into a shape as shown in FIG. 2B.

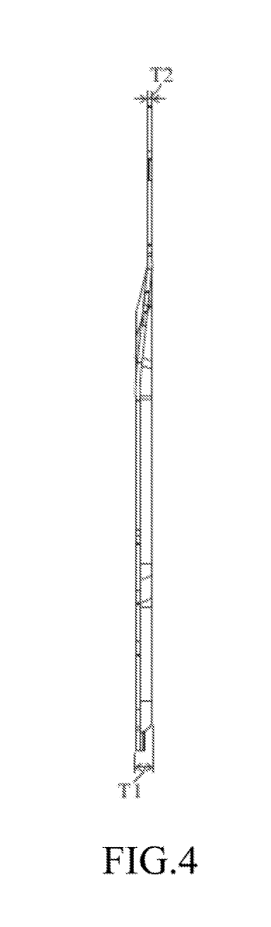

The first corner zone 211 and the second corner zone 212 are placed on raised portions of the mat placement area 3 when the mat 2 is placed on the floor either under a driver seat or under an adjacent passenger seat. The raised portions (i.e., so called wheel arch) are formed due to the provision of wheel or gearbox. For making the mat 2 fully engage the uneven portions of the mat placement area 3 of floor placed either under a driver seat or under an adjacent passenger seat. As shown in FIG. 4, it is a side view of the mat 2 in which the foot resting zone 21a has a first thickness T1 and each of the first and second corner zones 21b, 21c has a second thickness T2 less than the first thickness T1. The thinness of the first and second corner zones 21b, 21c enables the mat 2 to be more flexible and the grooves 21f to be more bendable. As a result, the mat 2 can be fully engaged with the different mat placement areas 3 of all vehicles.

Further, the third corner zone 21d and the fourth corner zone 21e are placed on a joining portion of the mat placement area 3 and a car seat when the mat 2 is placed either under a driver seat or under an adjacent passenger seat. The joining portion is made to have a curved edge for decoration. The plurality of curved, intersected grooves 21f are formed on the third corner zone 21d and the fourth corner zone 21e respectively so that the third corner zone 21d and the fourth corner zone 21e can be bent easily.

As shown in FIG. 2A, a longitudinal central line L (indicated by broken lines) passes through the first side 211 and being perpendicular thereto, the foot resting zone 21a, and the fourth side 214 and being perpendicular thereto. The first and second corner zones 21b, 21c are symmetrical with respect to the central line L. Also, the curved, intersected grooves 21f on the first corner zone 21b and that on the second corner zone 21c are symmetrical with respect to the central line L. Likewise, the second side 212 and the third side 213 are symmetrical with respect, to the central line L and the third corner zone 21d and the fourth corner zone 21e are symmetrical with respect to the central line L respectively. In other words, the mat 2 is a symmetrical shape about the longitudinal central line L. And in turn, the mat 2 can be placed on the mat placement area 3 either under a driver seat or under an adjacent passenger seat.

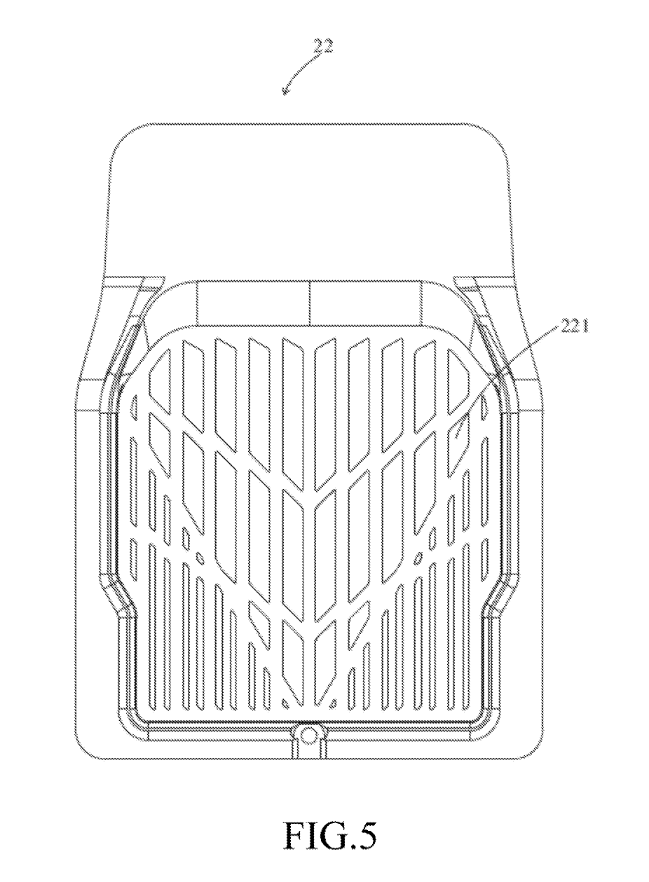

The front surface 21 of the foot resting zone 21a is provided with a plurality of slip-resistant projections 21g so that the mat 2 of the invention can be made slip-resistant. FIG. 5 shows a back view of the mat 2. The mat 2 has a back surface 22 opposite to the front surface 21. The back surface 22 contacts the mat placement area 3 when the mat 2 is placed on the mat placement area 3. A plurality of slip-resistant protrusions 221 are provided on the back surface 22 for keeping a constant friction between the mat placement area 3 and the back surface 22. Thus, the mat 2 is prevented from slipping relative to at least one of the mat placement areas.

As mentioned above, the mat for all vehicles of the invention, as compared with the typical car mat, is characterized by the following: The curved, intersected grooves are oriented in different direction so that the mat can be securely placed on the car floor by overcoming irregularities of the car floor. The mat can be cut to accommodate the provision of the gas pedal, the brake pedal and even the clutch pedal. The mat can be perfectly placed on the floor under a driver seat or an adjacent passenger seat. And in turn, there is no need for car mat manufacturers to produce different car mats. As a result, the manufacturing cost is greatly reduced.

While the invention has been described in terms of preferred embodiments, those skilled in the art will recognize that the invention can be practiced with modifications within the spirit and scope of the appended claims.

What is claimed is:

1. A mat for all vehicles including one mat placement area under a driver seat or an adjacent passenger seat, the mat being placed on the area, comprising:
a front surface including a foot resting zone, a first corner zone at one end of a front portion of the front surface of the mat, and a second corner zone at the other end opposed to the first corner zone of the front portion of the front surface of the mat;
wherein each of the first and second corner zones is formed with a plurality of curved, intersected grooves so that the first and second corner zones are bendable to enable the mat to completely engage the area; and
wherein the mat is adapted to cut to accommodate the area so that the mat is capable of completely engaging the area.

2. The mat according to claim 1, wherein the mat further comprises a back surface opposing the front surface, the back surface being contact the mat placement area when the mat is placed on the mat placement area under the driver seat or the adjacent passenger seat.

3. The mat according to claim 2, wherein the mat further comprises a first side, a second side, and a third side opposed to the second side, wherein both ends of the first side are joined the second side and the third side respectively, and wherein the curved, intersected grooves extend from the second side to the first side and the third side to the first side respectively.

4. The mat according to claim 3, wherein the foot resting zone has a first thickness and each of the first and second corner zones has a second thickness less than the first thickness.

5. The mat according to claim 4, further comprising a longitudinal central line passes through the first side and the foot resting zone so that the first and second corner zones are symmetrical with respect to the central line and the second side and the third side are symmetrical with respect to the central line.

6. The mat according to claim 5, wherein the mat further comprises a third corner zone at one end of a rear portion of the mat and a fourth corner zone at the other end opposed to the third corner of the rear portion of the mat, and wherein each of the third and fourth corner zones is formed with a plurality of curved, intersected troughs.

7. The mat according to claim 6, wherein the mat further comprises a fourth side opposing the first side, wherein both ends of the fourth side are joined the second side and the third side respectively, and wherein the foot resting zone is abutted the fourth side.

8. The mat according to claim 7, wherein the first corner zone is at a joining portion of the first side and the second side, and wherein the second corner zone is at a joining portion of the first side and the third side.

9. The mat according to claim 8, further comprising a plurality of slip-resistant protrusions formed on the back surface of the mat.

10. The mat according to claim 9, further comprising a plurality of slip-resistant projections formed on the foot resting zone of the front surface of the mat.
